(19) United States
(12) Patent Application Publication
(10) Pub. No.: US 2015/0278894 A1
(43) Pub. Date: Oct. 1, 2015

(54) Management And Brokering Of The Purchase of Placements Over A Network

(71) Applicants: David Edward Reeder, Malibu, CA (US); Curtis W.M. Bowden, Los Angeles, CA (US); Gary Shenk, Seattle, WA (US); Mark Owens, Pacific Palisades, CA (US)

(72) Inventors: David Edward Reeder, Malibu, CA (US); Curtis W.M. Bowden, Los Angeles, CA (US); Gary Shenk, Seattle, WA (US); Mark Owens, Pacific Palisades, CA (US)

(73) Assignee: CORBIS CORPORATION, Seattle, WA (US)

(21) Appl. No.: 14/679,264

(22) Filed: Apr. 6, 2015

Related U.S. Application Data
(63) Continuation-in-part of application No. 12/268,409, filed on Nov. 10, 2008.

(51) Int. Cl. G06Q 30/06

(52) U.S. Cl. CPC G06Q 30/0611

(57) ABSTRACT

Embodiments are directed towards providing a computer-implemented method for negotiating the purchase of a placement that communicates a rights holder interface over a network to a rights holder for dynamically accessing terms of an offer, the offer based at least in part on a request by a rights requester to purchase a placement controlled by the rights holder, wherein the rights holder interface includes a control accessible to the rights holder for dynamically revising terms of the offer, receives from the rights holder over the network a counteroffer that includes an indication of a revision by the rights holder to at least one of the terms of the offer, evaluates the counteroffer received from the rights holder and determines that the terms of the counteroffer, including the at least one revised term, are acceptable; and communicates a confirmation of the counteroffer to the rights holder.

### RELATED APPLICATIONS

This application is a continuation-in-part of U.S. patent application Ser. No. 12/268,409 filed on Nov. 10, 2008, which is a continuation-in-part of U.S. application Ser. No. 11/763,347, filed on Jun. 14, 2007, now U.S. Pat. No. 8,073,828, the contents of which is hereby incorporated by reference, and is related to U.S. patent application Ser. No. 14/136,906 filed Dec. 20, 2013, the contents of which is hereby incorporated by reference.

### FIELD OF ART

The invention is directed to the brokering of rights in assets and media opportunities, and more particularly, to brokering and managing negotiations to purchase media opportunities or placements.

### BACKGROUND

Some computerized trading systems enable a user to enter a purchase request and receive a purchase confirmation. Some computerized auction systems enable a user to submit a bid, overcome another user's bid, and purchase an item. Some computerized project management systems enable a supervisor to approve a task. However, existing computer systems generally do not enable a rights requester to propose and negotiate terms with rights holders to clear the rights to use assets, such as multimedia assets. Individual rights requesters can contact each rights holder, and each decision maker within a rights holder organization, to seek clearance for using the asset. It is difficult and slow for rights requesters to determine requirements of rights holders, especially rights holders that require approvals from a number of decision makers within a rights holder organization. It is also difficult and slow for rights holders to track, prioritize, respond to, and otherwise manage a number of requests from rights requesters. In addition, it is difficult and slow for rights holders to aggregate and analyze information about numerous requests and their dispositions. It is with regard to these and other issues that embodiments of the present invention are directed.

Product placement refers to the placement of product and brand advertising integrated within media such as movies, television programs, songs, Web photos and videos and the like such that the advertising is integrated within the media. Thus, unlike traditional advertising, product placements do not disrupt the continuity of the media. Examples include an actor holding a specific beverage product in a movie where the beverage product's label is prominently featured, an actor driving a specific type of car within a television program, a song that mentions a specific product, or a photo of a celebrity published on a Web page in which the celebrity is wearing a specific brand of clothing. Product placement is a form of advertising but is different from conventional advertising and is not addressed by existing computer-based advertising systems, tools and platforms.

Thus, it would be desirable to provide an automated system to enable rights holders of media assets, including rights holders of product placements, assist with management and brokering tasks including negotiation of terms with rights requesters.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 shows one embodiment of an environment in which the invention may be practiced;

FIG. 2 illustrates one embodiment of a network device that may be included in a system implementing the invention;

FIG. 3 shows one embodiment of an opportunities brokering architecture that manages negotiations for rights clearances to use assets;

FIG. 4 illustrates one embodiment of a web interface provided to a rights holder for managing requests for rights clearances to use assets;

FIG. 5 shows one embodiment of a rights holder web interface illustrating revised terms of a request for rights clearances to use assets;

FIG. 6 illustrates one embodiment of a mobile client device displaying a list portion of a rights holder web interface for managing rights clearances to use assets;

FIG. 7 shows one embodiment of a mobile client device displaying a detailed description portion of a rights holder web interface for managing rights clearances to use assets;

FIG. 8A illustrates one embodiment of a rights clearance interface provided for a user in response to an initial request from a client for usage rights approval for at least one asset;

FIG. 8B shows one embodiment of a rights clearance interface provided to a rights holder indicating that an opportunity exists to sell at least usage rights of at least one of their assets to a particular client;

FIG. 8C illustrates one embodiment of a rights clearance interface provided to a user for selecting one or more types of assets to add to a client's project for approval of usage rights by a rights holder;

FIG. 9A shows an exemplary data schema for bounding the business domain of the assignment of assets rights for a client's project on behalf of a rights holder;

FIG. 9B illustrates an exemplary schema for bounding the business domain of a client's project, assets, and usage rights;

FIG. 9C shows an exemplary schema for bounding the business domain of an opportunity by a user to negotiate at least usage rights by a client on behalf of a rights holder;

FIG. 9D illustrates an exemplary schema for bounding the business domain of an opportunity by a user to negotiate at least usage rights for a client's project that includes one or more assets on behalf of one or more rights holders;

FIG. 10 illustrates one embodiment of a user interface that provides placement opportunities to a buyer and enables the buyer to interactively select placement opportunities for purchase; and

FIG. 11 depicts a pricing model, referred to herein as a media value matrix, that is used to estimate the value of a placement based on three key factors.

### DETAILED DESCRIPTION

The present invention now will be described more fully hereinafter with reference to the accompanying drawings, which form a part hereof, and which show, by way of illustration, specific embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein the following terms have the meanings given below:

Media asset or asset—refers to an individual item of media such as a song, album, video clip, movie, digital image, animation or the like.

Impression—refers to a viewing or listening of a piece of media such as a movie, television program, Web video, song, or photo by one person.

CPM—refers to a standard cost metric that means the price charged by a publisher for a conventional advertisement or placement in a piece of media for one thousand impressions or views.

Channel—as used herein refers to a category of media in which a product placement can be made. Channels include television, movies, music, printed advertisements, Web video advertisement, Web image advertisements, and the like.

Media vehicle or vehicle—refers to a specific piece of media such as a specific television program, film, video, song or other piece of media in which a product placement may be made.

Vehicle power—refers to a rating of the intrinsic value of a particular vehicle piece of media to a media buyer, for example a TV program, a film, etc. This can be determined by factors such as the viewership of the vehicle, cast, director, buzz, etc. It may be noted that CPM for conventional advertising in television programs doesn't always correlate to the program's viewership. This may be due to the fact that some shows attract higher value demographics than others and hence receive a higher CPM even when it has a smaller audience. In one embodiment vehicle power is stated as a letter value, e.g. A, B, or C where A refers to vehicles that have more value, and are thus more costly to advertise in and C refers to vehicles that have more value and thus are less expensive to advertise in.

Branded product placement, product placement or placement—means the integration of a display, appearance, or mention of a product or brand within a vehicle. The media may be audio or visual, or both, such as within a music video. A placement is different than a conventional advertisement in that it is integrated with the media content, i.e. there is continuity between the media content of the vehicle and the placement. Thus, the storyline of the vehicle is not disrupted and the viewer does not perceive a placement as a separate advertisement. For example, a viewer can choose not to watch a commercial inserted into a television program and not miss the program content itself. Integration of a product placement into a vehicle means that if the viewer doesn't see the placement they miss viewing or listening to at least a portion of the vehicle content. The term product placement refers to advertisements for specific products as well as to more general advertisements for brands, e.g. when a company logo might appear rather than a specific product. Examples of placements include an actor in a movie driving a specific model of car during a chase scene, an actor holding a specific, easily recognizable beverage, in a movie, film, or photo, or a mention of a specific product in a song. Pricing of placements has not previously been standardized in the way that pricing for conventional advertisements have. Thus, creating a model and an automated method for estimating the value and hence price of a placement is itself novel and unique.

Placement duration or simply duration—refers to the amount of time during a media segment, e.g. during a film or TV show or song, that a placement occupies. For example, if a placement consists of an actor holding a can of soda in a film the duration would be the length of time in which the actor appears holding the can of soda.

Media Vehicle or vehicle—refers to a specific piece of media such as a specific television program, film, video, song, web advertisement or other piece of media in which a product placement may be made.

Opportunity—As used herein, the term opportunity can refer to an opportunity to purchase, license, use or otherwise exploit any type of asset or service including inter alia media assets such as digital images, videos, songs and albums, placements, advertisement or advertising segments. An opportunity typically includes restrictions or terms that govern the use of the asset or service such as geographical, temporal, or type of usage. When used in the context of a product placement, opportunity means a potential placement in a vehicle that may be purchased by a media buyer.

### Illustrative Operating Environment

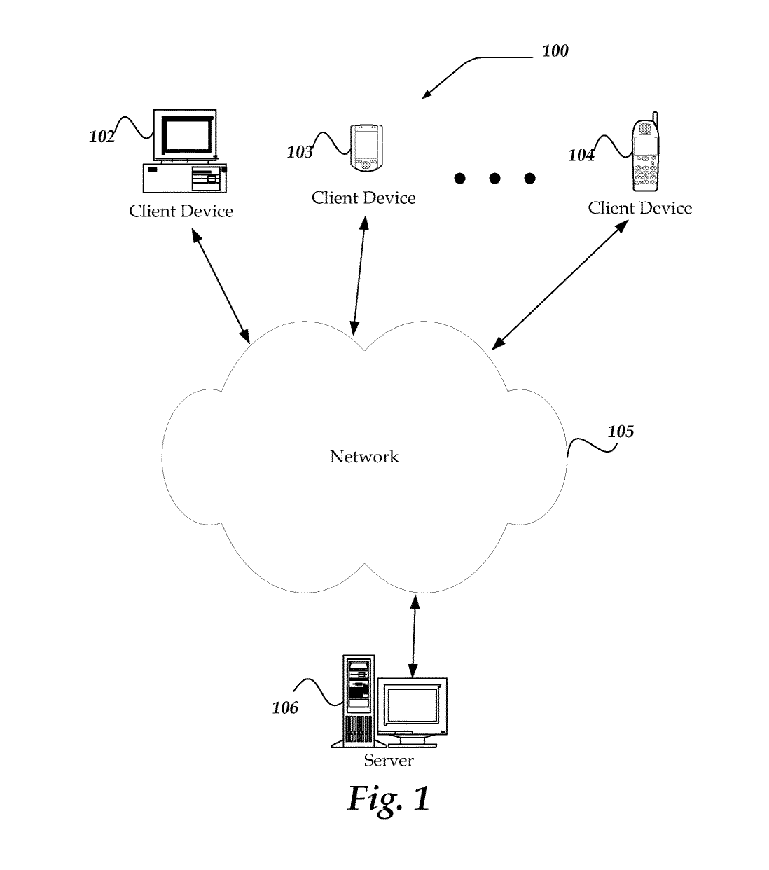

FIG. 1 illustrates one embodiment of an environment in which the present invention may operate. However, not all of these components may be required to practice the invention, and variations in the arrangement and type of the components may be made without departing from the spirit or scope of the invention.

As shown in the figure, a system 10 includes client devices 102-104, a network 105, and a server 106. Network 105 is in communication with and enables communication between each of client devices 102-104, and server 106.

Client devices 102-104 may include virtually any computing device capable of receiving and sending a message over a network, such as network 105, to and from another computing device, such as server 106, each other, and the like. The set of such devices may devices that are usually considered general purpose devices and typically connect using a wired communications medium such as personal computers, multiprocessor systems, microprocessor-based or programmable consumer electronics, network PCs, and the like. The set of such devices may also include mobile terminals that are usually considered more specialized devices and typically connect using a wireless communications medium such as cell phones, smart phones, pagers, walkie talkies, radio frequency (RF) devices, infrared (IR) devices, CBs, integrated devices combining one or more of the preceding devices, or virtually any mobile device, and the like. Similarly, client devices 102-104 may be any device that is capable of connecting using a wired or wireless communication medium such as a personal digital assistant (PDA), POCKET PC, wearable computer, and any other device that is equipped to communicate over a wired and/or wireless communication medium. The client devices may be used by content providers, content distributors, content purchasers, system administrators, and the like.

Each client device within client devices 102-104 includes a user interface that enables a user to control settings, and to instruct the client device to perform operations. Each client device also includes a communication interface that enables the client device to send and receive messages from another computing device employing the same or a different communication mode, including, but not limited to email, SMS, MMS, IM, internet relay chat (IRC), Mardam-Bey's internet relay chat (mIRC), Jabber, and the like. Client devices 102-104 may be further configured with a browser application that is configured to receive and to send web pages, web-based messages, and the like. The browser application may be configured to receive and display graphics, text, multimedia, and the like, employing virtually any web based language, including, but not limited to Standard Generalized Markup Language (SGML), HyperText Markup Language (HTML), Extensible Markup Language (XML), a wireless application protocol (WAP), a Handheld Device Markup Language (HDML), such as Wireless Markup Language (WML), WMLScript, JavaScript, and the like.

Network 105 is configured to couple one computing device to another computing device to enable them to communicate. Network 105 is enabled to employ any form of medium for communicating information from one electronic device to another. Also, network 105 may include a wireless interface, such as a cellular network interface, and/or a wired interface, such as the Internet, in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize cellular telephone signals over air, analog telephone lines, full or fractional dedicated digital lines including T1, T2, T3, and T4, Digital Signal level 3 (DS3), Optical Carrier 3 (OC3), OC12, OC48, Asynchronous Transfer Mode (ATM), Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between client devices 102-104, and server 106. Network 105 is constructed for use with various communication protocols including transmission control protocol/internet protocol (TCP/IP), WAP, code division multiple access (CDMA), global system for mobile communications (GSM), and the like.

The media used to transmit information in communication links as described above generally includes any media that can be accessed by a computing device. Computer-readable media may include computer storage media, wired and wireless communication media, or any combination thereof. Additionally, computer-readable media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wireless media such as fluids or space for acoustic, RF, infrared, and other wireless signals, and wired media such as twisted pair, coaxial cable, fiber optics, wave guides, and other wired media.

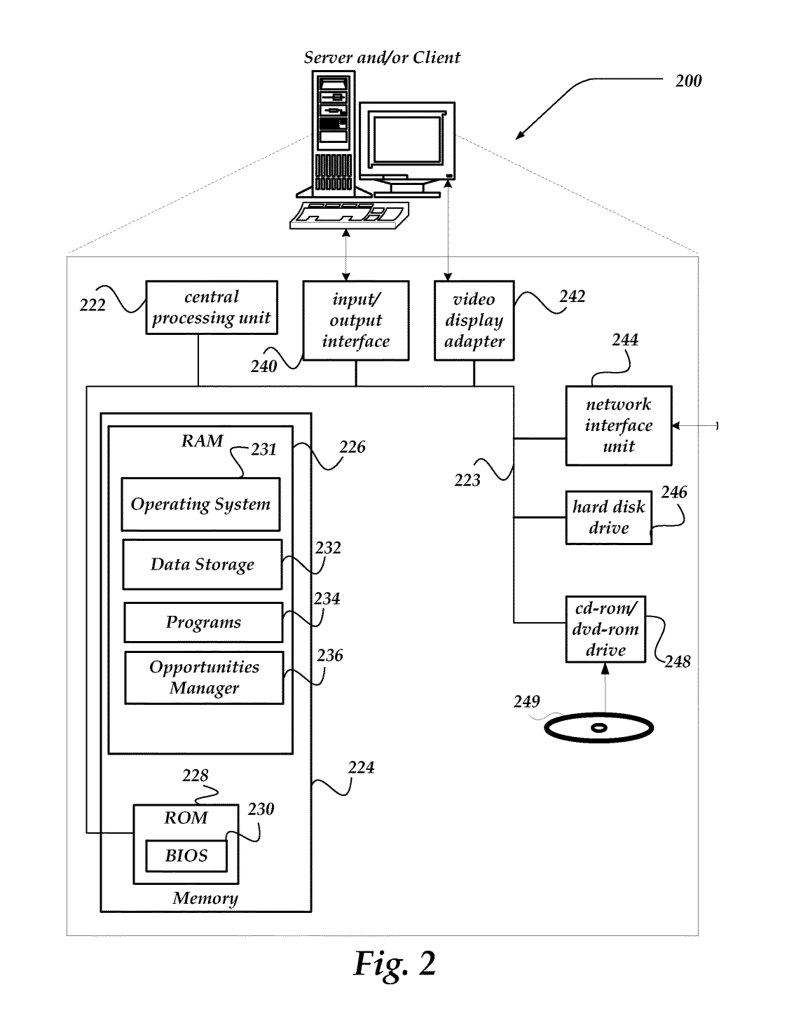

One embodiment of a general purpose computing device, such as a computing device 200, is described in more detail below in conjunction with FIG. 2. Computing device 200 may be used as a server device and/or a client device. Briefly, computing device 200 may include any computing device capable of connecting to network 105 to enable a user to communicate with other client devices and/or server 106. Computing device 200 may include many more components than those shown. The components shown, however, are sufficient to disclose an illustrative embodiment for practicing the invention.

As shown in the figure, computing device 200 includes a processing unit 222 in communication with a mass memory 224 via a bus 223. Mass memory 224 generally includes a RAM 226, a ROM 228, and other storage means. Mass memory 224 illustrates a type of computer-readable media, namely computer storage media. Computer storage media may include volatile and nonvolatile, removable and non-removable media implemented in any method or technology for storage of information such as computer readable instructions, data structures, program modules or other data. Other examples of computer storage media include EEPROM, flash memory or other semiconductor memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

Mass memory 224 stores a basic input/output system (“BIOS”) 230 for controlling low-level operation of computing device 220. The mass memory also stores an operating system 231 for controlling the operation of computing device 220. It will be appreciated that this component may include a general purpose operating system such as a version of Windows™, UNIX or LINUX™. The operating system may also include, or interface with a Java virtual machine module that enables control of hardware components and/or operating system operations via Java application programs.

Mass memory 224 further includes one or more data storage units 232, which can be utilized by computing device 220 to store, among other things, programs 234 and/or other data. Programs 234 may include computer executable instructions which can be executed by computing device 220 to implement an HTTP handler application for transmitting, receiving and otherwise processing HTTP communications. Similarly, programs 234 can include an HTTPS handler application for handling secure connections, such as initiating communication with an external application in a secure fashion. Other examples of application programs include schedulers, calendars, web services, transcoders, database programs, word processing programs, spreadsheet programs, and so forth. Accordingly, programs 234 can process web pages, audio, video, and enable telecommunication with another user of another electronic device.

Depending on the particular use of computing device 200, mass memory 224 stores an opportunities management module 236. Opportunities management module 236 may include computer executable instructions, which may be run under control of operating system 231 to process negotiations for asset usage rights, placement opportunities, and/or other client and/or server aspects of asset rights management.

Computing device 200 also includes an input/output interface 240 for communicating with input/output devices such as a keyboard, mouse, wheel, joy stick, rocker switches, keypad, printer, scanner, and/or other input devices not specifically shown in FIG. 2. A user of computing device 200 can use input/output devices to interact with a user interface that may be separate or integrated with operating system 231 and/or programs 234. Interaction with the user interface includes visual interaction via a display, and a video display adapter 242.

Computing device 200 may include a removable media drive 244 and/or a permanent media drive 246 for computer-readable storage media. Removable media drive 244 can comprise one or more of an optical disc drive, a floppy disk drive, and/or a tape drive. Permanent or removable storage media may include volatile, nonvolatile, removable, and non-removable media implemented in any method or technology for storage of information, such as computer readable instructions, data structures, program modules, or other data. Examples of computer storage media include a CD-ROM 249, digital versatile disks (DVD) or other optical storage, magnetic cassettes, magnetic tape, magnetic disk storage or other magnetic storage devices, RAM, ROM, EEPROM, flash memory or other memory technology, or any other medium which can be used to store the desired information and which can be accessed by a computing device.

Via a network communication interface unit 244, computing device 200 can communicate with a wide area network such as the Internet, a local area network, a wired telephone network, a cellular telephone network, or some other communications network, such as network 105 in FIG. 1. Network communication interface unit 244 is sometimes known as a transceiver, transceiving device, network interface card (NIC), network adapter, and the like.

### Illustrative Architecture & Processing

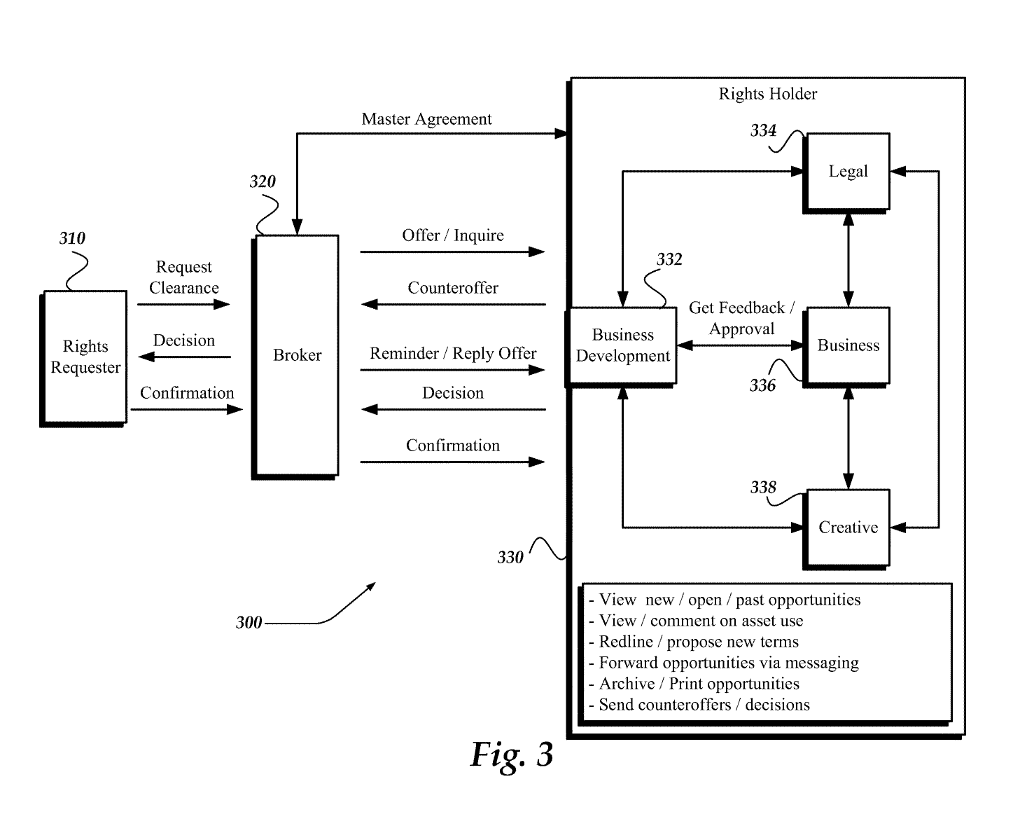

Reference is now made to FIG. 3, which is a simplified diagram of an opportunities brokering architecture 300 that manages negotiations for rights clearances to use assets, in accordance with an embodiment of the present invention. A rights requester 310 requests a rights clearance through a broker 320. The rights requester can send an electronic request to a rights requester interface of the broker, such as through a rights requester web page. The rights requester may request a rights clearance for an individual asset, or for multiple assets that comprise a project, such as an advertising campaign. The rights requester may simply identify the project and list of assets. The broker can then determine the rights holders and obtain rights clearances. For example, the rights requester may provide information on a proposed advertising campaign, and request that the broker obtain approval from appropriate rights holders. Specifically, the broker may determine that a rights clearance is needed from a film studio to use one or more images, video clips, or audio clips of an actor for use in the advertising campaign.

The broker stores the request in a database with information about the request. The database may include, or be coupled to a rights clearance and tracking system, which may manage multiple aspects of rights clearances related to requests. One aspect may be directed to identifying and tracking rights clearances for all assets of a project. An asset and project oriented aspect of a rights clearance and tracking system is disclosed in U.S. patent application Ser. No. 11/763,347, entitled “Licensed Rights Clearance And Tracking For Digital Assets,” filed Jun. 14, 2007. However, each project and each asset may require rights clearances from multiple rights holders. Thus, the rights clearance and tracking system may also include an aspect that is oriented toward managing the negotiation process with rights holders. Embodiments of the present invention are directed toward this negotiations aspect. One embodiment may comprise an opportunities manager, for tracking and otherwise managing negotiations of rights clearances with various rights holders. Rights holders, brokers, and/or rights requesters may use embodiments of the present invention.

The broker may have, or may arrange, a master agreement with a rights holder 330, where the master agreement defines general contract terms that are to be applied to a number of individual agreements. The broker may then manage negotiations for individual usage rights requested by various rights requesters. Similarly, the broker may have a master agreement with rights requesters that is suited to the relationship between the broker and the rights requesters.

The broker may provide one or more interfaces to the rights requesters and/or the rights holders. The examples below, primarily describe one or more interfaces to rights holders. But those skilled in the art will recognize the similar interfaces may be provided for the broker and/or for rights requesters. In this embodiment, the broker uses a rights holder interface to communicate with one or more rights holders. The broker proposes opportunities to one or more rights holders, and exchanges counter proposals with the rights holders. In this example embodiment, the opportunities may be referred to as offers and/or counteroffers, but the invention is not limited to formal use of these terms. For instance, the broker may propose an opportunity to the rights holder, who then offers to license the use of an asset under particular terms. The broker, or the rights requester may then accept the offer. In any case, the broker monitors progress of negotiations, sends reminders, and completes transactions with the rights holder.

Rights holder 330 may use a browser to access broker 320 for past, current, and new rights usage opportunities. The figure illustrates an example sequence of communications for negotiating clearance to use an asset controlled by the rights holder. The rights requester may inform the broker of a project that involves the use of one or more assets controlled by one or more rights holders. The broker provides information to each rights holder and negotiates clearances to use the corresponding assets for the project.

In one example, the rights requester provides information to the broker on assets desired for use in a project by the rights requester. In some cases, the rights requester may identify a specific asset that is requested, and may provide a sample of how the asset will be used. The rights requester may submit the request information via a requester web page, electronic messages, or other communications. The rights requester also submits a request to the broker to obtain required clearances to use the assets. The broker establishes a record and/or tables in a database to manage the individual request and/or the project. The broker submits an offer to the rights holder on behalf of the rights requester. Alternatively, or in addition, the rights holder accesses the broker database, such as via a Web browser, to review any new, pending, or past opportunities. In one embodiment, the broker provides a dynamic web page to the rights holder, which accesses data on opportunities that are associated with the particular rights holder. The web page may include script or other dynamic interaction modules that enable the rights holder to modify, sort, filter, and otherwise manipulate information about opportunities associated with the rights holder. Similarly, the broker may provide an alert, email message, web page pop-up, or other reminder or submit an inquiry to the rights holder regarding an opportunity on which the rights holder has not yet acted.

A number of rights holder individuals, client modules, or other entities may access the broker's information in one or more ways. For example, a business development entity 332 may access all information associated with the rights holder, using a security key, a particular account, session control with a particular client module, or the like. The business development entity may use the web page to exchange information with other entities of the rights holder. For instance, the business development entity may exchange all information, or a subset of information, with a legal entity 334. A legal entity may access a similar web page from the broker, or a different web page that is tailored to the needs of the legal entity. Similarly, a business entity 336, and or a creative entity 338 may receive information from other entities, and access information about opportunities. Each entity may edit the information and/or provide feedback to other entities, and/or to the broker. Each entity can access revisions and communications through the broker web interface. If the broker detects a rights holder delay or other issue associated with the proposal, the broker can issue a reminder to the rights holder and/or to a broker operator, propose an alternative (e.g., a preconfigured alternative or a dynamically initiated alternative), and/or take other action.

If the rights holder is not satisfied with the proposed offer, the rights holder may use a local script or other tool to edit the offer, and send a counteroffer to the broker. The counteroffer generally comprises a message from the rights holder browser to the broker with the revisions made by the rights holder. For example, a script may detect changes to fields of a web page form, and communicate the changes to the broker. In addition, or alternatively, the rights holder may enter revisions into form fields of the web page, and submit the page to the broker. The submission may include a project identifier, session identifier, rights holder identifier, rights requester identifier, or other identifier for the broker to associate the submission to the corresponding data stored by the broker. The broker may evaluate the counteroffer and take action directly with the rights holder. For example, the broker may have predefined price ranges, usage terms, duration terms, or other terms that can be automatically accepted. Alternatively, the broker may communicate the counter offer to a broker operator and/or the rights requester for further instructions regarding the counteroffer.

If the broker automatically, or manually, agrees with the counteroffer from the rights holder, the broker may send a confirmation to the rights holder. Alternatively, the broker may communicate a reply offer. The confirmation or reply offer may be pushed to the rights holder via a message, such as an alert, and e-mail, an SMS message, or the like. In addition, or alternatively, the confirmation or reply offer may be made available to the rights holder when the rights holder next accesses the broker database via web page interface. If needed, the broker can send a reminder after delay period, or may propose another alternative if the broker detects an issue or other problem in obtaining approval of the reply offer.

If the reply offer does not timeout, the broker may receive an additional counteroffer or a decision from the rights holder. The broker can automatically act on the decision, notify a broker operator, and/or relay the decision to the rights requester. The rights requester may send a confirmation or rejection to the broker, which may take further action and/or relay the confirmation or rejection to the rights holder. If the broker receives a rejection from the rights requester, the broker may also receive additional counter offer information from the rights requester which is proposed to the rights holder. If the broker receives a confirmation, the broker can initiate an invoice, receipt, and/or other accounting process. The broker may perform the accounting processing or communicate information to an accounting module. Aggregated information about the exchanges, revisions, or other actions can also be stored and analyzed to determine common issues and possible improvements to the negotiation process.

### Illustrative Interfaces

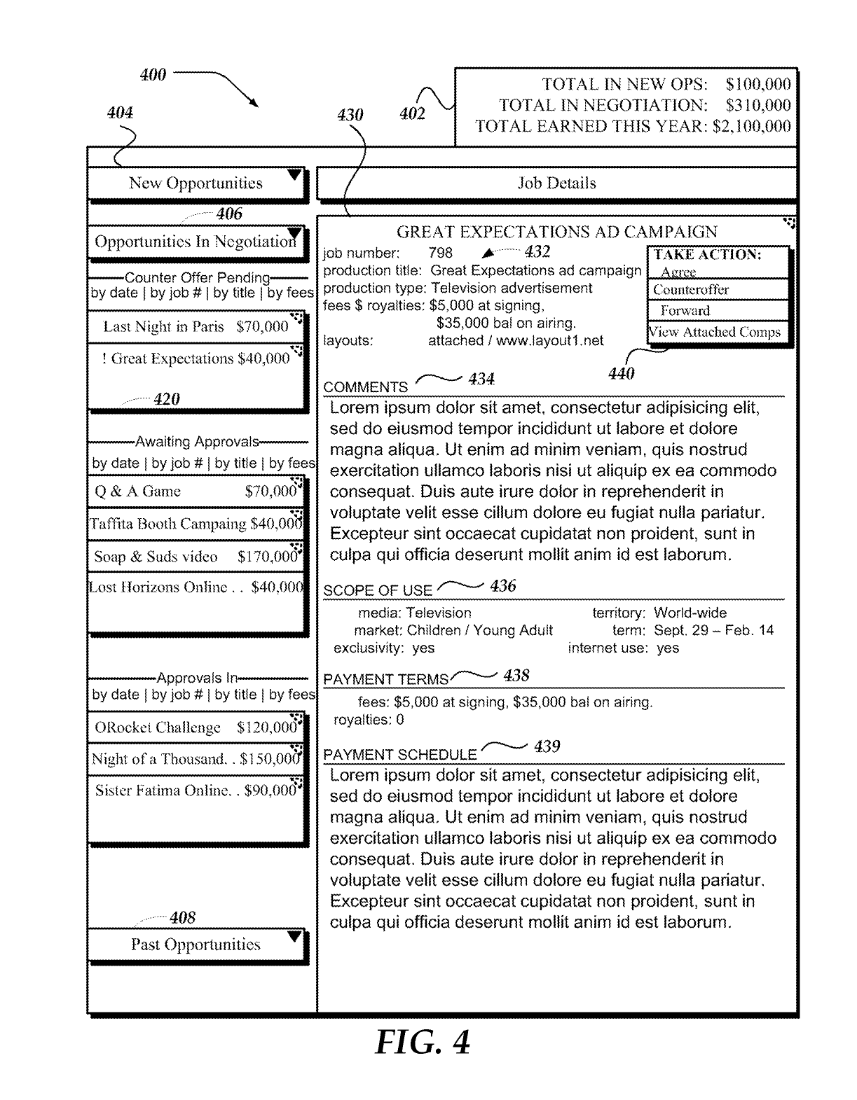

FIG. 4 shows one embodiment of a rights holder web interface 400 provided to a rights holder through a client browser for managing requests for rights clearances to use assets. The same or a similar web interface may be available to rights requesters or the broker. Rights holder web interface 400 includes a summary section 402 that summarizes opportunities associated with the viewing rights holder. For example, the summary section may indicate a total value of new opportunities that has been proposed but have not yet been processed. Similarly, the summary section may indicate a total value of opportunities that are still in negotiation, such as opportunities that the rights holder has revised or submitted counter offers. The summary section may also include a total value of completed transactions. The summary section may further include, or may link to, other information, such as quantities of opportunities, lists of requesters, date information, or the like.

The rights holder web interface includes lists of opportunities in various stages of processing. A new opportunities interface element 404 may be selected to view a list of new requests for approval to use assets controlled by the rights holder. The rights holder may click on the new opportunities interface element to open the list of new opportunities. Selecting the new opportunities interface element may cause a message to be communicated to the broker, requesting the list of new opportunities. The broker may return a revised web page or just the list of new opportunities for display in the browser. Alternatively, the list of new opportunities may be stored locally by the rights holder client. Selecting the new opportunities interface element may cause a script to execute and access the local list of new opportunities for display in the rights holder web interface.

The illustrated rights holder web interface also includes multiple lists of opportunities that are in various stages of negotiation. A rights holder may select a negotiation interface element 406 to view or

The illustrated rights holder interface also includes a past opportunities interface element 408, which may be selected to access opportunities that were accepted, rejected, deferred, lapsed, or otherwise closed.

The illustrated rights holder interface further includes details about a selected opportunity. For example, details of a selected opportunity 420 are shown in a details section 430. The illustrated details section includes a summary header 432 that provides basic information about the opportunity. Basic information may include a request identifier, such as a job number. Basic information may also include a production title corresponding to the rights requester's project. A production type may indicate with a use for which the asset is requested. The basic information also includes fees and royalties which the rights requester will pay to the rights holder to use the corresponding asset. The basic information may further include a link to an attachment or to a network resource that provides a sample of the project. For example, a sample advertisement layout may be attached to illustrate how the asset will be used. Similarly, the basic information, or another portion of details section 430 may include an attachment or link to the master agreement, or a draft formal agreement that includes the current terms of details section 430.

The details section may also include comments 434, which may further described the project, the asset use, the rights requester, or other information. Details section 430 may further include a scope of use description 436, which may provide additional details about the terms of use. In the illustrated example, the asset is to be used to in a television advertisement that is directed to the children and young adult markets. The asset may be used in a television advertisement anywhere in the world between September 29 and February 14. The use it is intended to be exclusive to the rights requester, and may be used via the Internet.

In this example, a payment terms section 438 indicates that a fee of $5,000 will be paid when the rights holder signs the agreement to allow use of the asset. The payment terms section also indicates that a balance of $35,000 will be paid when the advertisement is aired on television with the asset. The example payment terms indicate that no ongoing royalty will be paid. For further details regarding payment may be described in a payment schedule section 439.

To rights holder may revise the terms provided in the details section. In addition, or alternatively, the rights holder may select other actions through an action control element 440. The action control element may include buttons, drop-down menus, or other interface elements. In another embodiment, the action control element may be invoked by right clicking a mouse button. In the illustrated example, the rights holder may select to agree to the terms of the opportunity, causing the current terms to be communicated to the broker. The current terms may be the original terms or revised terms, depending on the actions taken during the negotiation process. If a user has revised the terms, the user may select to send the revised terms to the broker as a counteroffer. Alternatively, the rights holder may select to foreword the opportunity to another entity within the rights holder organization, or to any other user that has ability and/or authority to review the opportunity. Another option is for the rights holder to select to view attached comparable opportunities. Selecting this option, may cause attached or related opportunities to be displayed. Alternatively, selecting this option may cause the web browser to communicate a search request to the broker, which can search its database for opportunity is that have one or more similar terms. Such searching may be based on the rights holder, the rights requester, selected usage terms, a selected fee range, a selected royalty range, or other parameters.

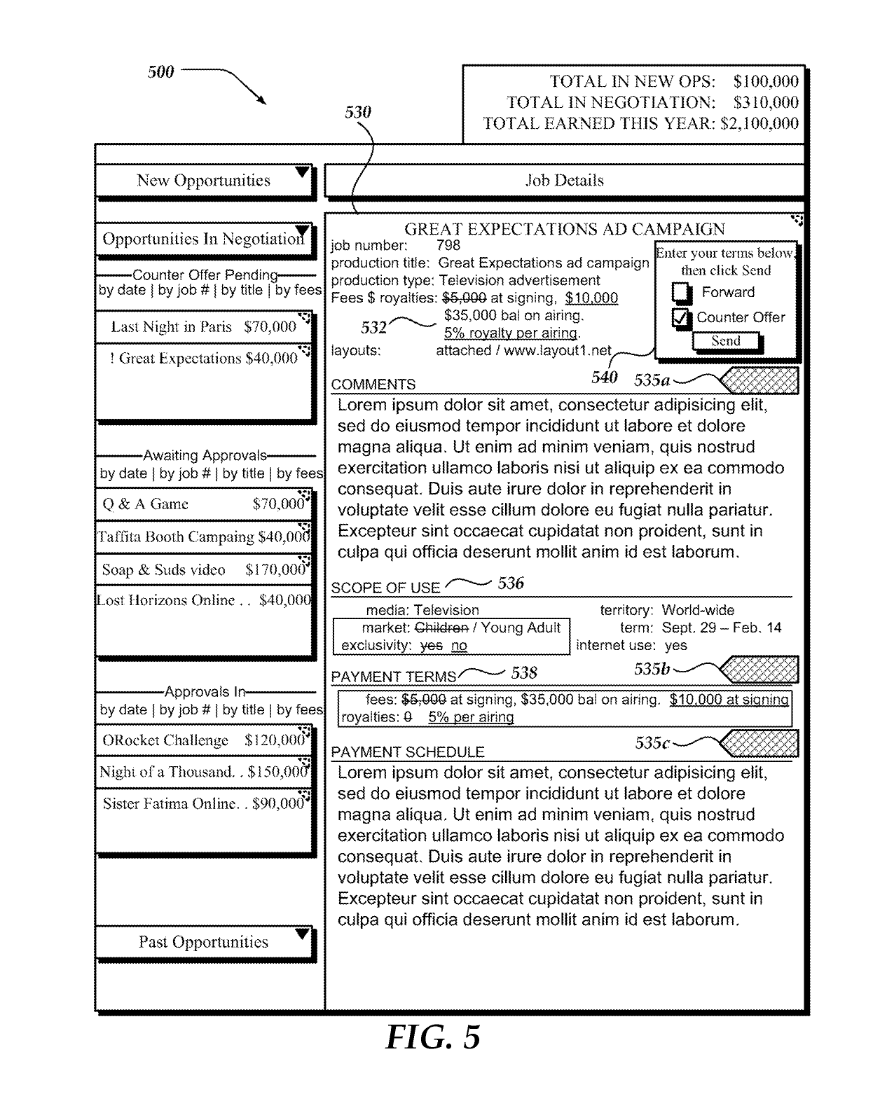

FIG. 5 shows one embodiment of a rights holder web interface 500 illustrating revised terms of a request for rights clearances to use assets. The client browser or device may include a script, a toolbar, or other editing module that enables a rights holder to edit the web page. In this example, the rights holder edited a details section 530 to change payment and usage terms. Specifically, the rights holder revised a payments summary 532 to change signing fees and to add an ongoing royalty requirement. When a change is made, the editing module indicates a deletion with strike through lines, and indicates additions with underlines. Highlighting, color, or other indications may also be used. In this embodiment, the editing module also adds a revision flag 535a to indicate that a revision was made nearby. A vertical revision bar, balloon icon, or other revision indicator may also be use. Similar changes are made, or reflected in payment terms section 538. The editing module may automatically cause a change in the payment terms section when revisions are made in payments summary 532, or vise versa. Another revision flag 535c is also displayed near the revised terms of the payments section. A revision box is also rendered around the revised terms to make the easier to locate.

Also shown, is a revision to a scope of use section 536. The rights holder deleted one of the proposed markets and changed the term defining whether the rights requester may have exclusive use of the asset for the term. A further revision flag 535b is also displayed near the revised terms of the scope of usage section, and a revision box is rendered around the revised terms. Each revision flag can be assigned an identifier and associated with data of the corresponding revision for further tracking, aggregating, analyzing, or other management of revision information, Users can also insert flags in other locations for other reasons. For example, the rights holder may want to place a reminder on one the opportunities in one of the lists. The rights holder may want to flag a certain term, or a portion of the detailed description to other entities within the rights holder organization. To add a flag, the rights holder may right click a mouse to access a menu with a flag function, and select a location on the web page to place a flag. Alternatively, or in addition, a toolbar button or other control can be used.

In other embodiments, each term of the details section may be provided through a selectable drop-down box, a set of check boxes, radio buttons, free-form data entry fields, or other data fields. The rights holder may simply select a different term. Each term may be associated with one or more other terms, such that a change to one term, causes a change to one or more other terms. The associations may be provided at the client with or stored at the broker. The web page, tool bar, or other associations module may update associated terms, when a change is made to a term on the web page. Alternatively, a change may be communicated to the broker, which returns a revised web page with changes to associated terms.

If no revisions are made, or after making revisions, the rights holder may forward the opportunity to other entities within the right holder organization for approval. In one embodiment, if a revision is made, or other action is taken, the interface controls may automatically change to provide options that are relevant to the state of the opportunity. For example, if revisions are made, the web page may execute a script or otherwise provide a different selectable interface control 540 that only enables the rights holder, or another entity, to forward or send a counter offer for the opportunity. In other embodiments, the rights holder may right click a mouse key, select a toolbar button, or perform another action to invoke a full menu or another limited menu to forward, or send a counter offer for the opportunity.

In a further embodiment, the rights holder may select to agree with the original terms and send the opportunity to another entity within the rights holder organization, or return an indication of agreement to the broker. Each entity within the rights holder organization can give a specific approval for a particular aspect (e.g., business, legal, creative). Conversely, each entity within the rights holder organization may select to forward a revised opportunity to other entities within the rights holder organization. Each entity, or only a single entity may have authority to return the revised opportunity as a counter offer. Similarly, the broker or rights requester may make revisions, and send a reply offer.

In another embodiment, the rights holder may select a number of opportunities, and perform a batch revision, batch forwarding, batch approval, or other batch processing to all of the selected opportunities. For example, the rights holder may hold a control key and select multiple opportunities from the lists, so that each selected opportunities is affected by a subsequent action. The details section may show details of one of the selected opportunities or may show a generic details section with default selectable controls for the terms. Generally, each action, or a summary of actions will be transmitted to the broker to process and return an updated web interface. But some, or all of the processing may be done at the client unless/until the database is to be updated.

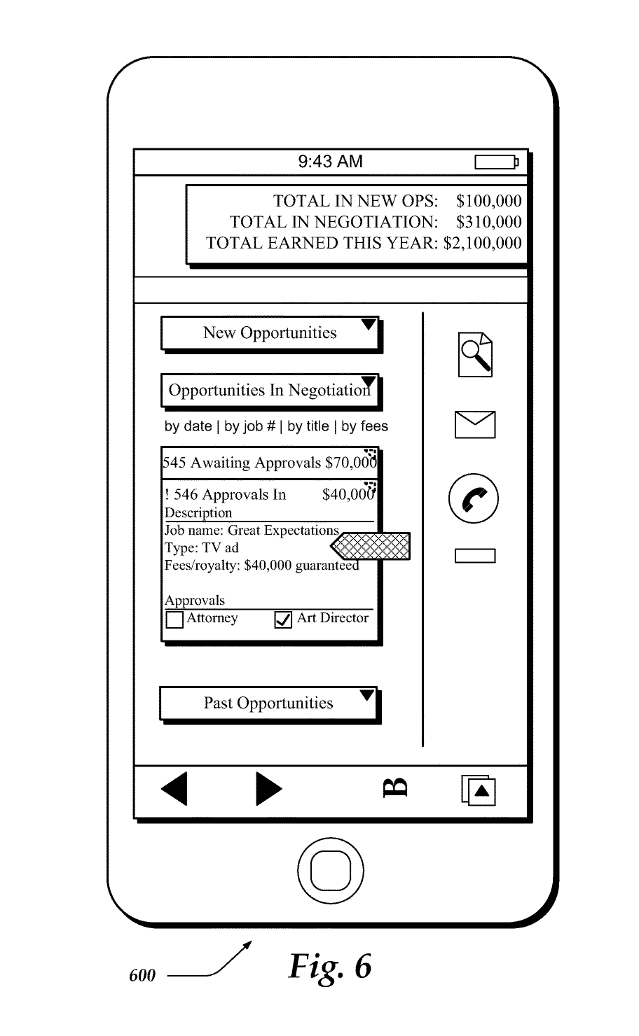

FIG. 6 shows one embodiment of a mobile client device 600 displaying a list portion of a rights holder web interface for managing rights clearances to use assets. In one example, a mobile rights holder may receive an alert, email message, or other notice of opportunities. The mobile rights holder may select a link in the notice, or initiate a mobile device browser to access the broker for a WAP page or other mobile interface for managing opportunities. The mobile rights holder may use a touch, a stylus, a trackball, a keypad, or other input device to make revisions, indicate an approval, forward to another entity, submit a counter offer, or perform other operations, such as those described above.

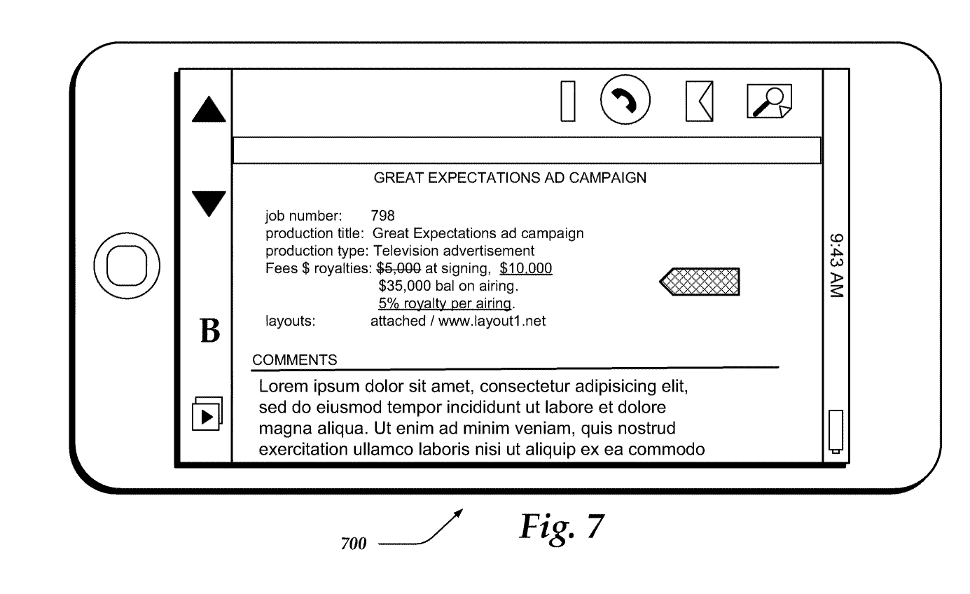

Similarly, FIG. 7 shows one embodiment of a mobile client device displaying a detailed description portion of a rights holder web interface for managing rights clearances to use assets.

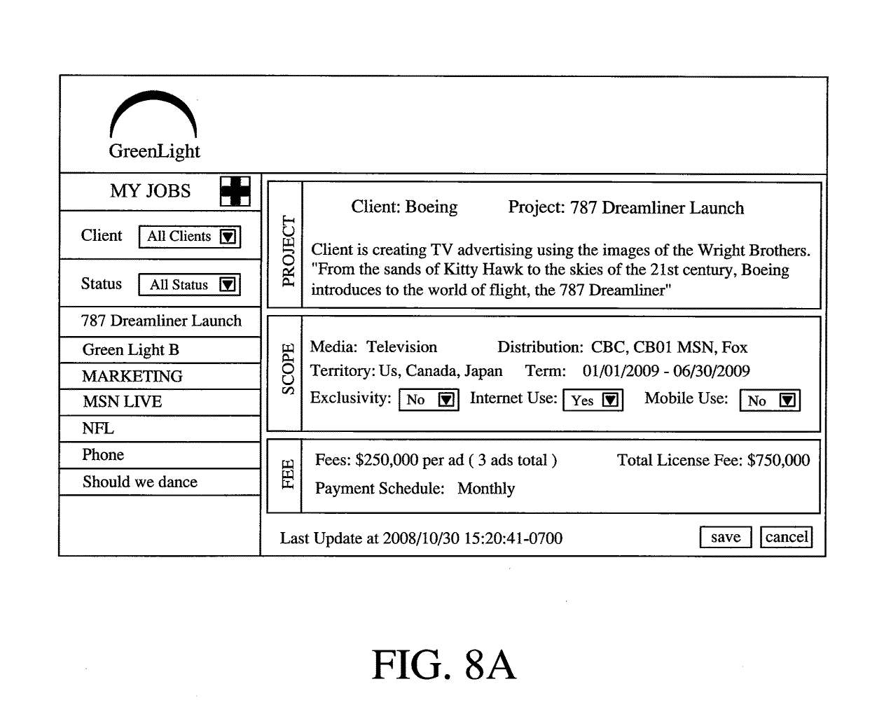

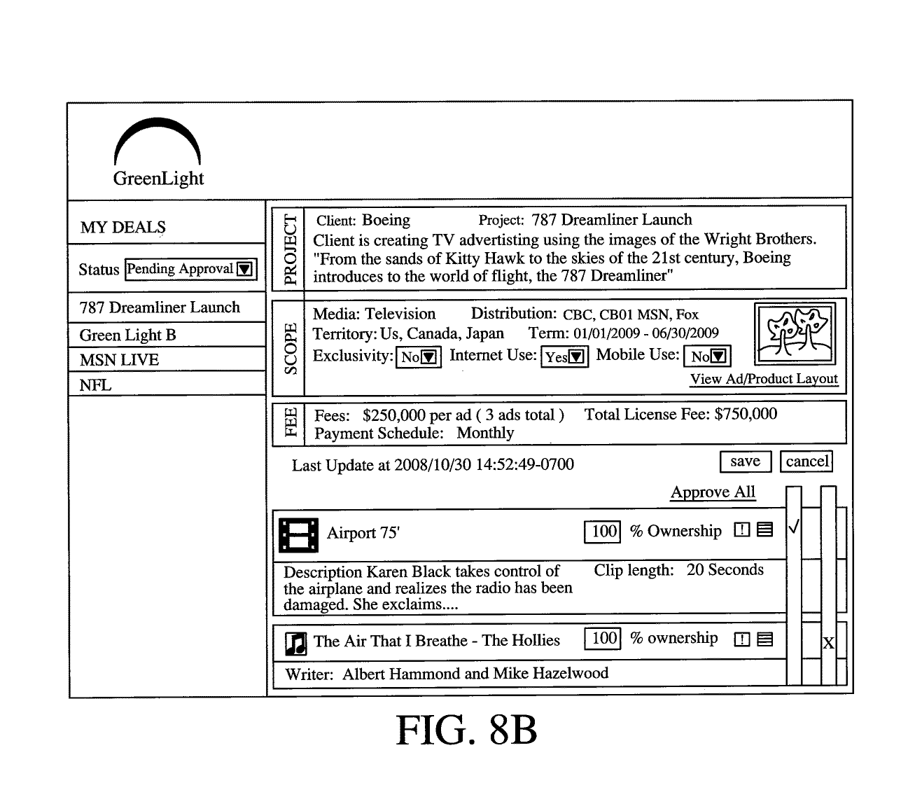

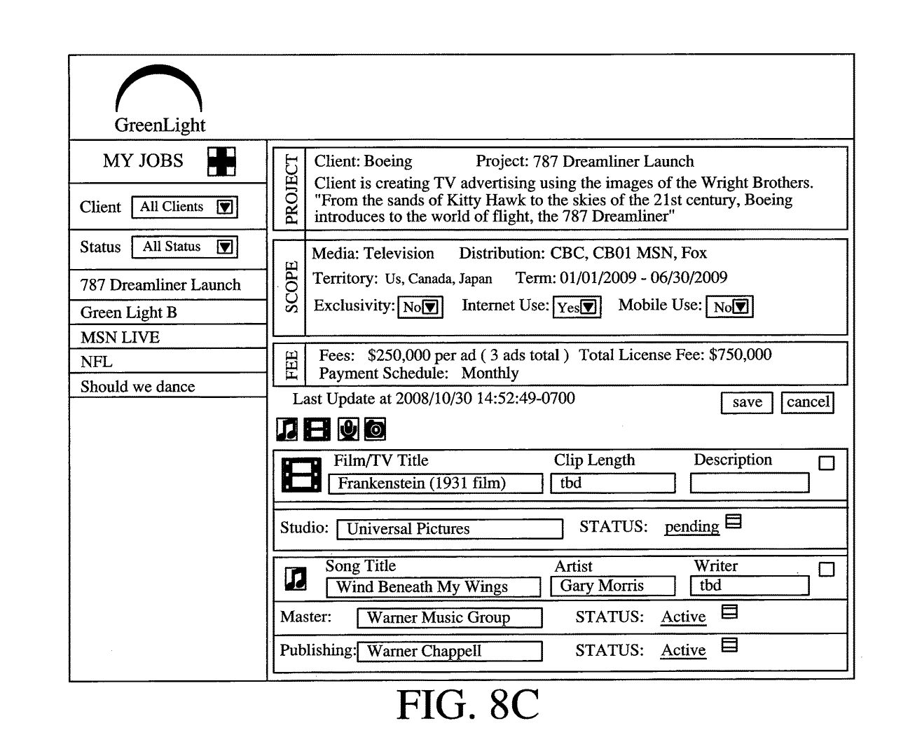

FIG. 8A illustrates one embodiment of a rights clearance interface that is displayed for a user in response to an initial request from a client (rights requester) to purchase usage rights approval for at least one asset. Similarly, FIG. 8B shows one embodiment of a rights clearance interface provided for display by a rights holder indicating that an opportunity exists to sell at least usage rights of at least one of their assets to a client. Also, FIG. 8C illustrates one embodiment of a rights clearance interface provided to the user for selecting one or more types of assets to add to a client's project for approval of usage rights by the rights holder. Furthermore, one or more of the interfaces shown in FIGS. 8A, 8B, and 8C may be provided as a web interface, mobile device interface, desktop application interface, or the like.

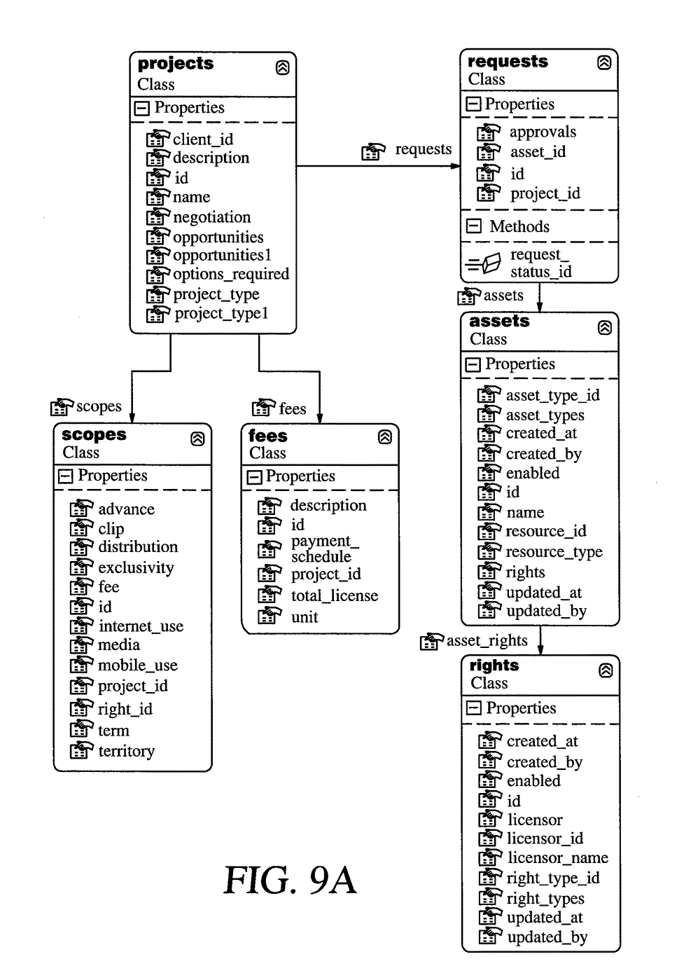

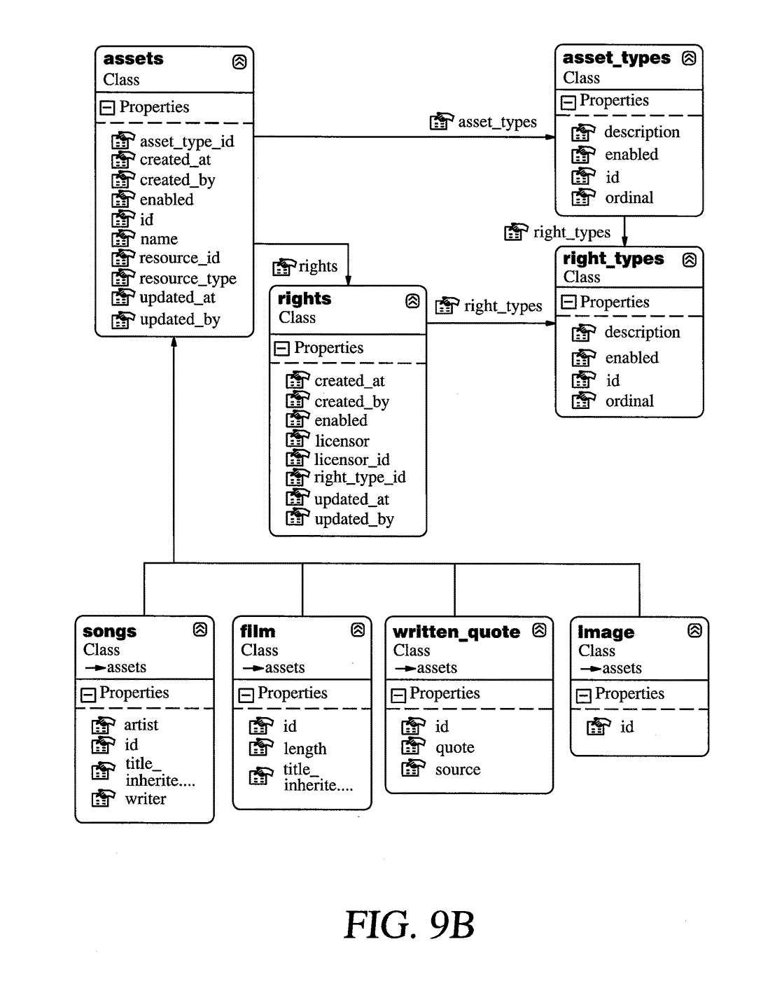

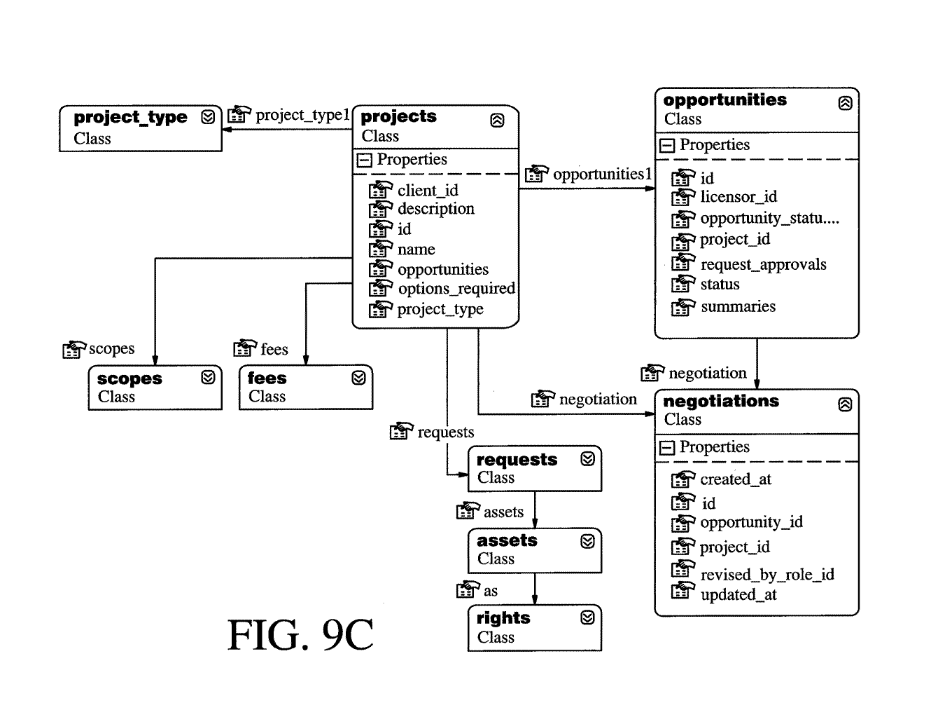

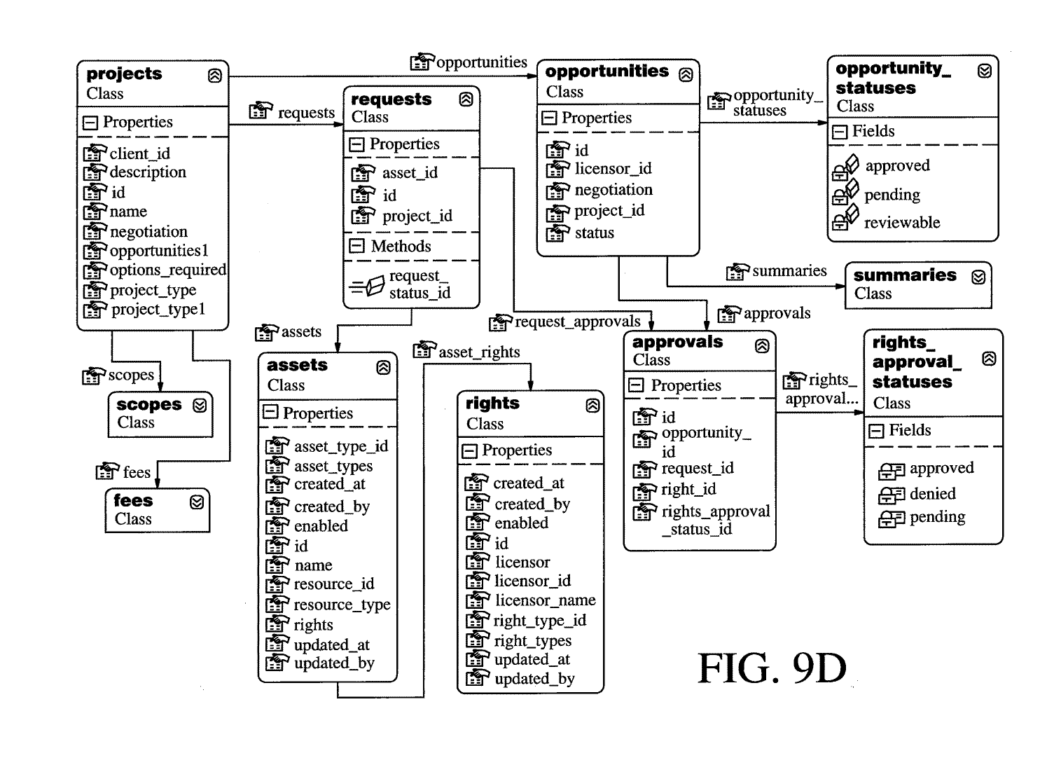

FIG. 9A shows an exemplary data schema for bounding the business domain of the assignment of assets rights for a client's project on behalf of a rights holder. As shown, the exemplary schema provides classification of projects, requests, scopes, fees, assets, and rights. FIG. 9B illustrates an exemplary data schema for bounding the business domain of an asset catalog. As shown, the schema provides classification of assets, rights, asset types, rights types, written quotes, images, films, and audio recordings such as songs. Additionally, FIG. 9C illustrates another exemplary data schema for bounding the business domain of an opportunity by a user to negotiate at least usage rights of assets by a client on behalf of a rights holder. As shown, the exemplary data schema provides classification of project type, projects, opportunities, negotiations, fees, scopes, requests, assets, and rights. Furthermore FIG. 9D illustrates an exemplary data schema for bounding the business domain of an opportunity by a user to negotiate at least usage rights for a client's project that includes one or more assets on behalf of one or more rights holders. As shown, the exemplary data schema provides classification of projects, scopes, fees, requests, assets, and rights.

### Embodiment for Managing the Negotiation of the Purchase of Placement Opportunities

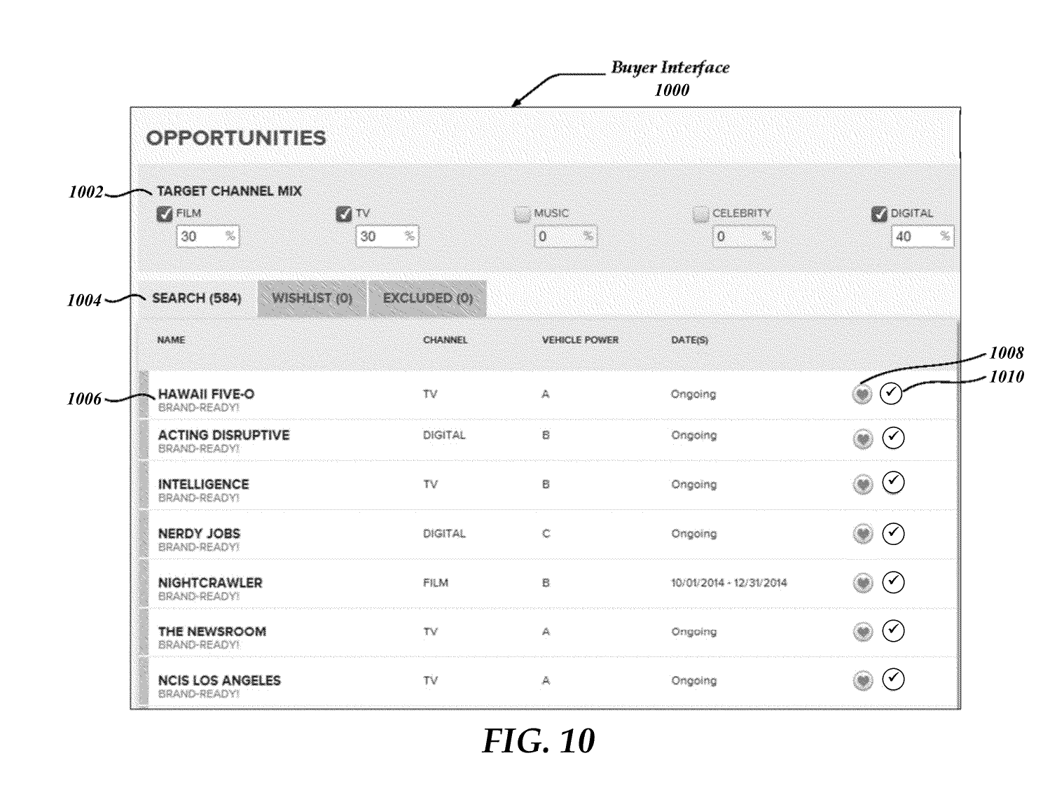

Opportunities brokering architecture 300 and its component modules and subsystems is capable of managing the negotiation for the purchase or license of product placement opportunities in addition to the previously discussed ability to manage aspects of the negotiations for rights clearances to use assets. An embodiment that specifically pertains to the use of opportunities broker architecture 300 for the purpose of negotiating the purchase of product placements is described hereinbelow with reference to FIG. 10.

FIG. 10 illustrates one embodiment of a user interface that provides placement opportunities to a buyer and enables the buyer to interactively select product placement opportunities for purchase. In response to media plan inputs provided by a buyer, a product placement service such identifies and provides a list of available opportunities to a buyer of product placements using a user interface such as buyer interface 1000. Buyer interface 1000 enables a buyer view, select and further refine opportunities for inclusion in a media plan. A channel mix control 1002 enables the buyer to specify the percentage of the budget to allocate to different media channels. While the channels illustrated in this example embodiment include film, TV, music, celebrity and digital (i.e. Web media), other channels may be included or channels illustrated may be omitted without departing from the scope and spirit of the subject invention. If the buyer un-checks the checkbox next to a channel then no budget is allocated to this channel. Further, in some embodiments the percentages may reflect a target percentage of impressions, rather than a percentage of budget to allocate to each channel. Using controls 1004 the buyer can view opportunities that have been added to a wishlist or an excluded list. In this embodiment, an opportunity list 1006 displays a list of opportunities identified by a placement service. Additionally, the buyer can perform keyword searches to select individual opportunities or groups of opportunities for inclusion or exclusion in the media plan. Two controls are available for each opportunity. An include control 1008 enables the buyer to indicate that he/she wants to include an opportunity and similar opportunities in the media plan. Included opportunities are added to the wishlist. A select control 1010 enables the buyer to indicate that he/she wants to negotiate the purchase of the selected opportunity. In other embodiments, include control 1008 is used to indicate that a specific opportunity should be included and an omit control may be provided (not pictured) may be used to indicate that a specific opportunity should be excluded.

In certain embodiments, if an opportunity is selected using select control 1010 rights requester 310 issues a request to purchase the opportunity to broker 320. In turn broker 320 formulates an offer and provides the offer to rights holder 330. The interactions between rights requester 310, broker 320 and rights holder 334 in respect to the purchase of a placement opportunity mirror the interactions between those parties with respect to the purchase or license of an asset, as described with reference to FIGS. 3-7 and 8A-C. For example, rights requester 310 may request to purchase one or more placement opportunities. Rights requester 310 may provide information about the proposed use of the placement opportunity and request that broker 320 obtain approval to make the placement from appropriate rights holders. Broker 320 may manage negotiations for individual placements requested by various rights requesters. Similarly, the broker rely on a master agreement with rights requesters with respect to placements that is suited to the relationship between the broker and the rights requesters. Rights requester 310, rights broker 320 and rights holder 330 may operate similarly with respect to requests, offers, counteroffers and reply offers as they do with respect to media assets. Rights requester 310 and rights holder 330 interfaces may operate similarly with respect to the purchase of product placements as they do with respect to the use of media assets.

### Pricing of Placements

It may be appreciated by one skilled in the art, that there is no standard pricing formula that can be applied to estimate the value achieved by a product placement. While the value of a conventional advertisement can be defined by its price which is typically given in a rate card provided by the seller of the advertising, the value of a product placement cannot be known until after the placement in a vehicle has actually occurred. This is because the placement is integrated into the media and the parameters of the placement can change substantially during creation of the vehicle, e.g. film, in which the placement occurs. In certain embodiments, the media value, i.e the value to the buyer, of a placement is estimated using available data that is collected and then assessed after the placement is made. Available data includes the impressions generated by a vehicle, such as a television program that was shown at a certain date and time, and demographic data about the audience for the vehicle. Available data may also include advertising rates for conventional advertisements such as TV ads, radio ads, Web ads.

A placement may be ranked relative to a number of factors that are used to estimate media value. In one embodiment, the factors are the media channel, the number of impressions, or viewers, of the placement, the vehicle power, placement quality and duration. In the cases of vehicle power, placement and duration a number of criteria are used to rank each of these factors. The criteria are used to rank or score the placement relative to each factor.

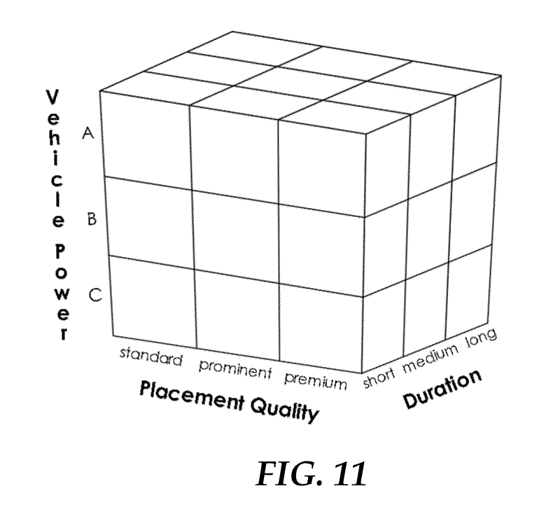

In certain embodiments a media value for a placement is based on a matrix of rankings for three key factors, illustrated in FIG. 11. FIG. 11 illustrates a pricing model, referred to herein as a media value matrix. In this embodiment, for a given channel the media value of impressions for a placement is estimated by the values in a 3 dimensional media value matrix, where the three axes are vehicle power, placement quality and duration. The values in each cell are in CPM units; however these are used herein to estimate the media value of impressions rather than to set actual prices. In other embodiments there may be more or less than 3 dimensions in a media value matrix. Further, in other embodiments, the values may be calculated by a mathematical expression or other algorithm rather than taken from a matrix without departing from the scope and spirit of the present invention.

In one embodiment, specific criteria that are used to rank a placement for vehicle power and placement quality are given below, in Table 1.

TABLE 1
Criteria Used To Rank a Placement Relative to Factors

| Factor | Criteria |
|---|---|
| Vehicle Power | Projected Viewership, or actual |
| | viewership of prior vehicles of |
| | the same series or media |
| | franchise |
| | Cast & Director |
| | Network & Timeslot (TV) |
| | Demographics |
| | Buzz |
| | Brand Appropriateness |
| | Heat Index (TV, Celebrity) |
| Placement Quality | Appropriateness & Believability |
| | Hands on Usage (of product |
| | being placed) |
| | Visibility of Product/Logo |
| | Verbal Mention (of Product or |
| | Brand) |
| | Implied Celebrity Endorsement |
| | Positive Brand Message |
| | Integration (of Product or |
| | Brand) with Storyline |

It may be appreciated that several of the criteria listed above in Table 1, such as buzz, and heat index are evaluated and provided by external services while others may be evaluated and entered by users. Vehicle power, or simply vehicle, criteria may be referred to as vehicle criteria in that they are used to evaluate aspects of the vehicle itself, independent of whether a placement is made. Thus, in one embodiment, vehicle power is evaluated prior to a placement being made and the vehicle power ranking for a vehicle may be displayed or otherwise provided to a buyer prior to a placement or media plan being made. In one embodiment, vehicle power is handled similarly with rankings denoted as A, B, or C. In one embodiment, vehicle power is ranked or graded based on the number of criteria, such as those identified in Table 1 above, that “deliver well”, i.e. achieve specific metrics. For example: a rank of A is assigned if the placement delivers well against four or five of the criteria specified in Table 1; a rank of B is assigned if two or three of the criteria deliver well; and a rank of C is assigned if less than two criteria deliver well.

Placement quality criteria, or simply placement criteria, are used to evaluate the quality of a placement. Placement criteria are typically evaluated after a placement has been produced. In one embodiment, placement quality is ranked similarly to vehicle power. In this embodiment, a rank of premium is assigned if the placement delivers well against four or five of the criteria specified in Table 1; a rank of prominent is assigned if two or three of the criteria deliver well; and a rank of standard is assigned if less than two criteria deliver well.

Duration is ranked based on the duration of a placement. For example, in one embodiment a rank of long is assigned if the placement duration is over 30 seconds, medium is assigned if the placements lasts 10-30 seconds, and short is assigned to placements that last under 10 seconds. As previously discussed, the duration of a placement can typically only be determined and hence a ranking performed after the vehicle that includes a placement has been produced.

It will be understood that each step of a flow description need not be limited in the ordering shown in the illustrations or described above, and might be performed in any ordering, or even performed concurrently, without departing from the spirit of the invention. It will also be understood that each step, and combinations of steps can be implemented by computer program instructions. These program instructions might be provided to a processor to produce a machine, such that the instructions, which execute on the processor, create means for implementing the actions specified in the steps. The computer program instructions might be executed by a processor to cause a series of operational steps to be performed by the processor to produce a computer implemented process such that the instructions, which execute on the processor to provide steps for implementing the actions specified in the illustrated or described step or steps.

Accordingly, steps of the flow illustration support combinations of means for performing the specified actions, combinations of steps for performing the specified actions and program instruction means for performing the specified actions. It will also be understood that each step of the flow illustration, and combinations of steps in the flow illustration, can be implemented by special purpose hardware-based systems which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter.

What is claimed is:

1. A computer-implemented method for negotiating the purchase of a placement performed by a network device that enables actions, comprising:
communicating a rights holder interface over a network to a rights holder for dynamically accessing terms of an offer, the offer based at least in part on a request by a rights requester to purchase a placement controlled by the rights holder, wherein the rights holder interface includes a control accessible to the rights holder for dynamically revising terms of the offer;
receiving from the rights holder over the network a counteroffer that includes an indication of a revision by the rights holder to at least one of the terms of the offer;
evaluating the counteroffer received from the rights holder and determining that the terms of the counteroffer, including the at least one revised term, are acceptable; and
communicating a confirmation of the counteroffer to the rights holder.

2. The method of claim 1, wherein the offer includes at least one term selected from the group consisting of a vehicle power, a placement quality and a duration.

3. The method of claim 1, wherein the offer includes pricing terms for purchase of the placement.

4. The method of claim 1, further comprising:
communicating a rights requester interface over the network to the rights requester, wherein the rights requester interface includes a control for requesting to purchase a placement controlled by the rights holder; and
receiving over the network the request by the rights requester to purchase the placement controlled by the rights holder.

5. The method of claim 1, further comprising:
receiving over the network from the rights requester an additional counteroffer; and
communicating the additional counteroffer over the network to the rights holder.

6. A network device for processing rights clearance to use an asset over a network, comprising:
a transceiver that is arranged to send and receive data over the network; and
a processor that is arranged to enable actions, including:
communicating a rights holder interface over the network to a rights holder for dynamically accessing terms of an offer, the offer based at least in part on request by a rights requester for the purchase of a placement controlled by the rights holder, wherein the rights holder interface includes a control accessible to the rights holder for dynamically revising terms of the offer;
receiving over the network a counteroffer that includes an indication of a revision by the rights holder to at least one of the terms of the offer; and
evaluating the counteroffer received from the rights holder and determining that the terms of the counteroffer, including the at least one revised term, are acceptable; and
communicating a confirmation of the counteroffer to the rights holder.

7. The network device of claim 6, wherein the offer includes at least one term selected from the group consisting of a vehicle power, a placement quality and a duration.

8. The network device of claim 6, wherein the offer includes pricing terms for the placement.

9. The network device of claim 6, wherein the processor is arranged to enable further actions, including:
communicating a rights requester interface over the network to the rights requester, wherein the rights requester interface includes a control for requesting to purchase a placement controlled by the rights holder; and
receiving over the network the request by the rights requester for the purchase of the placement controlled by the rights holder.

10. A processor readable non-transitory storage medium that stores computer readable instructions which enable actions for negotiating the purchase of a placement over a network, comprising:
communicating a rights holder interface over the network to a rights holder for dynamically accessing terms of an offer, the offer based at least in part on a request by a rights requester to purchase a placement controlled by the rights holder, wherein the rights holder interface includes a control accessible to the rights holder for dynamically revising terms of the offer;
receiving from the rights holder over the network a counter offer that includes an indication of a revision by the rights holder to at least one of the terms of the offer;
evaluating the counteroffer received from the rights holder and determining that the terms of the counteroffer, including the at least one revised term, are acceptable; and
communicating a confirmation of the counteroffer to the rights holder.

11. The processor readable non-transitory storage medium of claim 10, wherein the offer includes at least one term selected from the group consisting of a vehicle power, a placement quality and a duration.

12. The processor readable non-transitory storage medium of claim 10, wherein the offer includes pricing terms for purchase of the placement.

13. The processor readable non-transitory storage medium of claim 10, the actions further comprising:
communicating a rights requester interface over the network to the rights requester, wherein the rights requester interface includes a control for requesting to purchase a placement controlled by the rights holder; and
receiving over the network the request by the rights requester to purchase the placement controlled by the rights holder.

14. A system for negotiating the purchase of a placement over a network, comprising:
a rights holder client device that is operable to interact with a rights holder interface used by a rights holder; and
a broker network device arranged to enable actions, including:
communicating the rights holder interface over the network to the rights holder client device for dynamically accessing terms of an offer, the offer based at least in part on a request by a rights requester to purchase a placement controlled by the rights holder, wherein the rights holder interface includes a control accessible to the rights holder for dynamically revising terms of the offer;
receiving from the rights holder client device over the network a counteroffer that includes an indication of a revision by the rights holder to at least one of the terms of the request;
evaluating the counteroffer received from the rights holder and determining that the terms of the counteroffer, including the at least one revised term, are acceptable; and
communicating a confirmation of the counteroffer to the rights holder.

15. The system of claim 14, wherein the offer includes at least one term selected from the group consisting of a vehicle power, a placement quality and a duration.

16. The system of claim 17, wherein the offer includes pricing terms for purchase of the placement.

17. The system of claim 14, further comprising:
a rights requester client device associated with the rights requester, wherein the rights requester client device is operable to interact with a rights requester interface, wherein
the broker network device is arranged to enable further actions, including:
communicating the rights requester interface over the network to the rights requester client device, wherein the rights requester interface includes a control for requesting to purchase a placement controlled by the rights holder; and
receiving over the network the request to purchase the placement controlled by the rights holder from the rights requester client device.
